(19) United States
(12) Patent Application Publication
(10) Pub. No.: US 2021/0301684 A1
(43) Pub. Date: Sep. 30, 2021

(54) FLUIDIC FLOW CONTROL DEVICE

(71) Applicant: General Electric Company, Schenectady, NY (US)

(72) Inventor: Brian Robert HALLER, Rugby (GB)

(21) Appl. No.: 16/834,102

(22) Filed: Mar. 30, 2020

(51) Int. Cl. F01K 13/02; F15D 1/00; F01D 17/10

(52) U.S. Cl. CPC F01K 13/02; F01D 17/105; F15D 1/008

(57) ABSTRACT

The present application provides a turbine with a flow of steam therethrough. The turbine may include a first guide blade, a second guide blade, a flow path for the flow of steam therebetween, and a fluidic flow control device. The fluidic flow control device may include a bypass line for a portion of the flow of steam and an injection port for injecting the portion of the flow of steam into the flow path.

### TECHNICAL FIELD

The present application and the resultant patent relate generally to axial flow turbines such as steam turbines and the like and more particularly relate to a fluidic flow control device for improved steam turbine performance at part-load conditions without physical changes to the geometry of the internal components.

### BACKGROUND

Generally described, steam turbines and the like may have a defined steam path that includes a steam inlet, a turbine section, and a steam outlet. Steam generally may flow through a number of turbine stages typically disposed in series, including first or control stage blades with guides and runners (or nozzles and buckets) and subsequent guides and runners of later stages of the steam turbine. In this manner, the guides may direct the steam toward the respective runners, causing the runners to rotate and drive a load, such as an electrical generator and the like. The steam may be contained by circumferential shrouds surrounding the runners, which also may aid in directing the steam along the path.

There is an increasing need for steam turbines to provide fast operational response and improved performance at part-load conditions given the growth of renewable energy sources. Steam turbines may be used at part load to react to fluctuations in the availability of such renewable energy sources such as solar and wind. During such part-load conditions, the steam turbine needs to maintain a fixed minimum pressure mode to protect the boiler from overheating.

Current steam turbine control systems, however, are somewhat mechanically complex. For example, a throttle valve control throttles the flow to a lower pressure by closing the valve. Nozzle control or partial arc admission divides the flow into a number of arcs with each arc having a valve thereon such that the turbine swallows less steam as each arc is closed. In either case, overall steam turbine efficiency at part-load conditions is reduced given the required reduction in the flow. Specifically, as the load decreases, the throttling losses increase, and the overall cycle efficiency decreases.

### SUMMARY

The present application and the resultant patent thus provide a turbine with a flow of steam therethrough. The turbine may include a first guide blade, a second guide blade, a flow path for the flow of steam therebetween, and a fluidic flow control device. The fluidic flow control device may include a bypass line for a portion of the flow of steam and an injection port for injecting the portion of the flow of steam into the flow path.

The present application and the resultant patent further provide a method of operating a turbine with a first guide blade and a second guide blade at part load. The method may include the steps of providing a flow of steam to the turbine, diverting a portion of the flow of steam to within the first guide blade, flowing the remaining flow of steam between the first guide blade and the second guide blade, and injecting at an angle the diverted portion of the flow of steam into the remaining flow of steam through an injection port on the first guide blade.

The present application and the resultant patent further provide a turbine with a flow of steam therethrough. The turbine may include a first guide blade, a second guide blade, a flow path for the flow of steam therebetween, and a fluidic flow control device. The fluidic flow control device may include a bypass line for a portion of the flow of steam and an injection port on the first guide blade for injecting the portion of the flow of steam into the flow path at an angle.

These and other features and improvements of this application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a steam turbine with a high pressure section and an intermediate pressure section.

FIG. 2 is a schematic diagram of a portion of a steam turbine showing a stage with a guide blade and a runner blade and a portion of a fluidic flow control device as may be described herein.

FIG. 3 is a schematic diagram of a pair of guide blades with a portion of the fluidic flow control device of FIG. 2.

FIG. 4 is a schematic diagram of a first embodiment of an injection port of the fluidic flow control device of FIG. 2.

FIG. 5 is a schematic diagram of a second embodiment of an injection port of the fluidic flow control device of FIG. 2.

FIG. 6 is a schematic diagram showing an injection angle of the fluidic flow control device of FIG. 2.

FIG. 7 is a schematic diagram of a further embodiment of an injection port of a fluidic flow control device as may be described herein.

### DETAILED DESCRIPTION

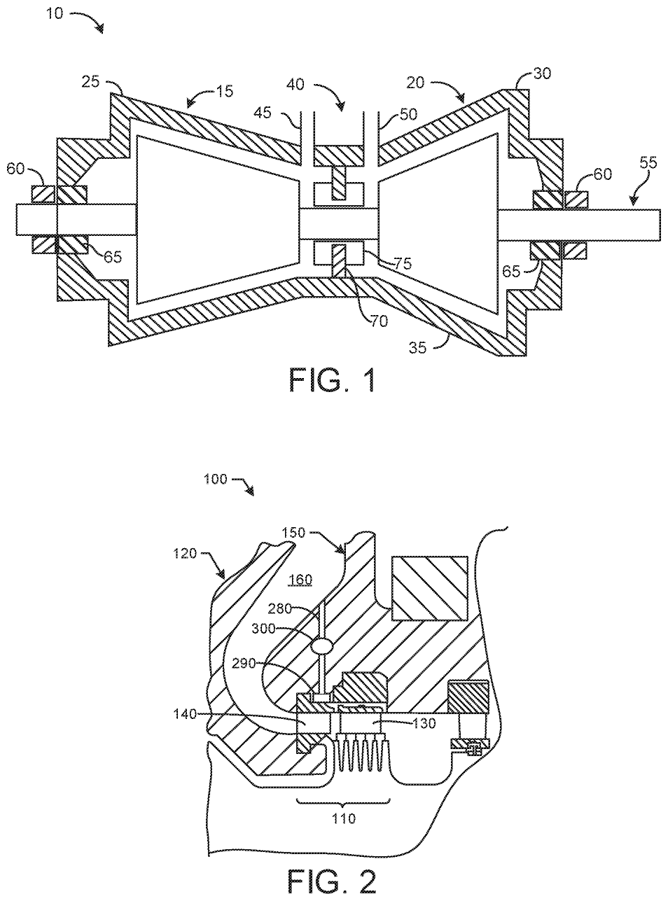

Referring now to the drawings, in which like numerals refer to like elements throughout the several views, FIG. 1 shows a schematic diagram of an example of a steam turbine 10. Generally described, the steam turbine 10 may include a high pressure section 15 and an intermediate pressure section 20. Other pressures and other sections also may be used herein. An outer shell or casing 25 may be divided axially into an upper half section 30 and a lower half section 35. A central section 40 of the casing 25 may include a high pressure steam inlet 45 and an intermediate pressure steam inlet 50.

Within the casing 25, the high pressure section 15 and the intermediate pressure section 20 may be arranged about a rotor or disc 55. The disc 55 may be supported by a number of bearings 60. A steam seal unit 65 may be located inboard of each of the bearings 60. An annular section divider 70 may extend radially inward from the central section 40 towards the disc 55. The divider 70 may include a number of packing casings 75. Other components and other configurations may be used.

During operation, the high pressure steam inlet 45 receives high pressure steam from a steam source. The steam may be routed through the high pressure section 15 such that work is extracted from the steam by rotation of the disc 55. The steam exits the high pressure section 15 and then may be returned to the steam source for reheating. The reheated steam then may be rerouted to the intermediate pressure section inlet 50. The steam may be returned to the intermediate pressure section 20 at a reduced pressure as compared to the steam entering the high pressure section 15 but at a temperature that is approximately equal to the temperature of the steam entering the high pressure section 15.

FIG. 2 shows a schematic diagram of a portion of a steam turbine 100 including a first or a control stage 110 of a high pressure section 120. The control stage 110 may have a number of rotating runner blades 130 and a number of static guide blades 140. Steam enters the steam turbine 100 in a partial arc admission configuration 150 through one or more steam inlet passages 160 provided with master valves (not shown) to turn the high pressure steam supply on or off as appropriate and to control the flow of steam through the runner blades 130 and through the guide blades 140. Any number of downstream stages also may be used. Other components and other configurations may be used herein.

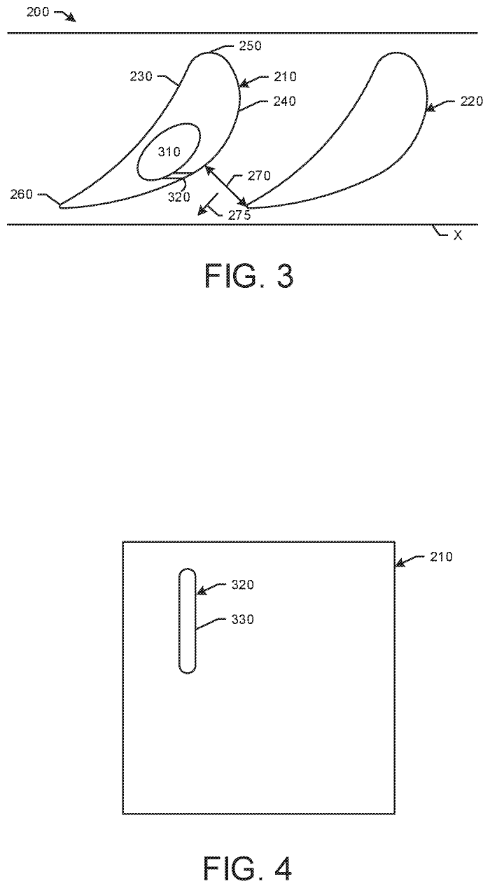

FIGS. 2 and 3 show an example of a fluidic flow control device 200 as may be described herein for use with the steam turbine 100 and the like. Specifically, FIG. 3 shows a pair of the guide blades 140, which may be described as a first guide blade 210 and a second guide blade 220. Each guide blade 210, 220 may have a pressure side 230 and a suction side 240 extending between a leading edge 250 and a trailing edge 260. The guide blades 210, 220 define a throat 270 therebetween. The throat 270 is defined as the shortest line extending from the trailing edge 260 of the second guide blade 220 normal to the suction side 240 of the adjacent first guide blade 210. A flow path 275 extends between the guide blades 210, 220. The guide blades 210, 220 may have any suitable size, shape, or configuration.

The fluidic flow control device 200 may include one or more bypass lines 280, as shown in FIG. 2. The bypass lines 280 may extend from the steam inlet passage 160 or elsewhere to a feed chamber 290 in communication with each row of the guide blades 140. Each of the bypass lines 280 may have a variable bypass valve 300 thereon. As is shown in FIG. 3, each of the guide blades 140 may have a steam passage 310 extending therethrough from the feed chamber 290 to an injection port 320. The injection port 320 may be positioned on the suction side 240 of each guide blade 140 at or adjacent to the throat 270.

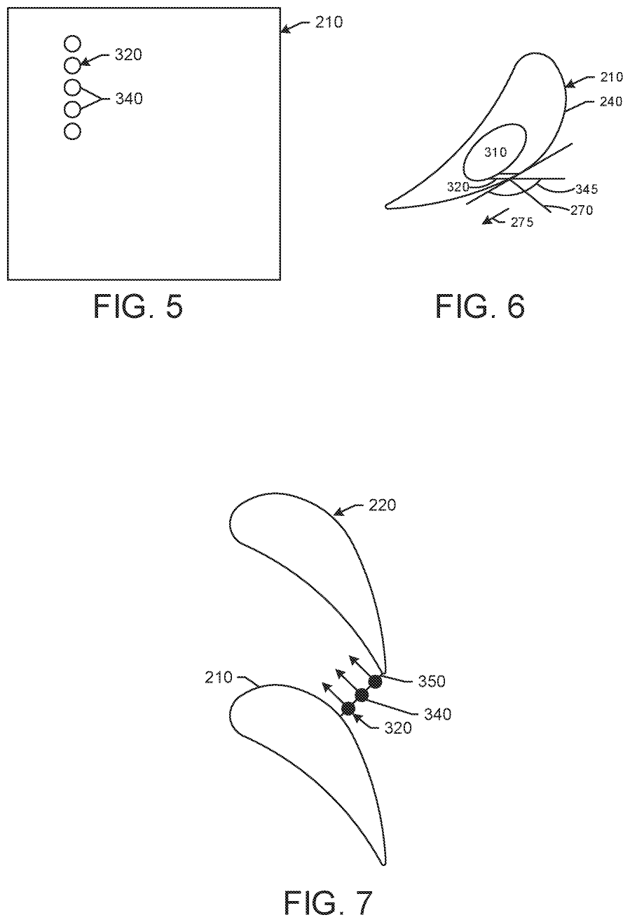

The injection port 320 may be a slot 330 extending along a portion of the length of the guide blade 140, 210, as shown in FIG. 4. The slot 330 may have a width of about ten to about twenty percent of the width of the throat 270 although the slot 330 may have any suitable size, shape, or configuration. Alternatively, the injection port 320 may be a number of apertures 340 extending along a portion of the length of the guide blade 140, 210, as shown in FIG. 5. Any number of the apertures 340 may be used. The apertures 340 may have any suitable size, shape, or configuration. Other components and other configurations may be used herein.

By injecting the diverted portion of the incoming steam flow into the flow path 275, the fluidic flow control device 200 reduces the incoming mass flow rate and, hence, reduces the overall swallowing capability of the turbine. As is shown in FIG. 6, an injection angle 345 at which the injection port 320 is positioned with respect to the flow path 275 has an impact on the effectiveness of the fluidic flow control device 200. The injection angle 345 may be about 135 degrees to about 150 degrees relative to the steam direction in the flow path 275 at the throat 270 (i.e., to the surface of the blade suction side 240 at the throat 270), as shown with the injection angle 345 of about 145 degrees being currently preferred.

The bypass line 280 may deliver up to about ten to about twenty percent of the total incoming flow to the injection port 320 of the fluidic flow control device 200. The amount of the bypassed flow may be varied. Static or dynamic feedback systems and the like may be used to control turbine output. All or any number of the guide blades 140 (210, 220) in any given row of guide blades 140 may have the injection port 320 of the fluidic flow control device 200 thereon.

Instead of reducing the number of active blade passages by closing arcs and the like as in the known nozzle control devices described above, the fluidic flow control device 200 described herein controls the flow path 275 between each pair of guide blades 140 by “blocking” some of the flow path 275 with a steam “jet,” i.e., effectively changing the geometry of the flow path 275 and therefore reducing the overall swallowing capacity. Because load control is provided by this (effective) geometry change, there is no throttling such that the expansion is more efficient at part-load conditions. Although this blocking feature hypothetically also might be achieved by changing the metal geometry of the guide blades 140 by reducing the height (for example, by reducing the throat between the guide blades 140, and the like), such a solution is not mechanically practical.

FIG. 7 shows a further embodiment of the fluidic flow control device 200 as may be described herein. In this case, the fluidic flow control device 200 may have the injection port 320 in an endwall 350 positioned between the guide blades 210, 220 along or adjacent to the throat 270. In the example, the injection port 320 may be a number of the apertures 340. The apertures 340 of the injection port 320 likewise inject the diverted flow of steam into the flow path 275 to provide a blocking function similar to that described above.

The fluidic flow control device 200 may be used in combination with existing throttle or nozzle control devices. The fluidic flow control device 200 may part of a retro-fit or may be original equipment. Although the fluidic flow control device 200 has been described in the context of the first or the control stage 110, there may be other location with similar flow control requirements, for example, a substantial variable steam extraction for an industrial process or district heating. The fluidic flow control device 200 and the like therefore may be useful therein. Other types of applications may be used herein.

It should be apparent that the foregoing description relates only to certain embodiments of this application and the resultant patent. Numerous changes and modifications may be made herein by one of ordinary skill in the art without departing from the general spirit and scope of the invention as defined by the following claims and the equivalents thereof.

I claim:

1. A turbine with a flow of steam therethrough, comprising:
a first guide blade;
a second guide blade;
a flow path for the flow of steam therebetween; and
a fluidic flow control device;
the fluidic flow control device comprising a bypass line for a portion of the flow of steam and an injection port for injecting the portion of the flow of steam into the flow path.

2. The turbine of claim 1, wherein the first guide blade comprises the injection port therein.

3. The turbine of claim 1, wherein the injection port is positioned about a suction side of the first guide blade.

4. The turbine of claim 1, wherein the injection port is positioned about the first guide blade at an angle of about 135 degrees to about 150 degrees with respect to the flow path at a throat.

5. The turbine of claim 1, wherein the injection port is positioned about the first guide blade at an angle of about 145 degrees with respect to the flow path at a throat.

6. The turbine of claim 1, wherein the injection port is positioned at a throat of the first guide blade and the second guide blade.

7. The turbine of claim 1, wherein the first guide blade comprises a steam passage in communication with the injection port.

8. The turbine of claim 1, wherein the injection port comprises a slot in the first guide blade.

9. The turbine of claim 1, wherein the injection port comprises a plurality of apertures in the first guide blade.

10. The turbine of claim 1, wherein the injection port comprises a plurality of apertures in an endwall between the first guide blade and the second guide blade along or adjacent to a throat.

11. The turbine of claim 1, wherein the turbine comprises a steam inlet passage for the flow of steam and wherein the bypass line is positioned about the steam inlet passage.

12. The turbine of claim 1, wherein the bypass line may deliver about ten to about twenty percent of the flow of steam to the fluidic flow control device.

13. The turbine of claim 1, wherein the bypass line has a variable bypass valve thereon.

14. The turbine of claim 1, wherein the turbine comprises a control stage with the fluidic flow control device therein.

15. A method operating a turbine with a first guide blade and a second guide blade at part load, comprising:
providing a flow of steam to the turbine;
diverting a portion of the flow of steam to within the first guide blade;
flowing the remaining flow of steam between the first guide blade and the second guide blade; and
injecting at an angle the diverted portion of the flow of steam into the remaining flow of steam through an injection port in the first guide blade.

16. A turbine with a flow of steam therethrough, comprising:
a first guide blade;
a second guide blade;
a flow path for the flow of steam therebetween; and
a fluidic flow control device;
the fluidic flow control device comprising a bypass line for a portion of the flow of steam and an injection port on the first guide blade for injecting the portion of the flow of steam into the flow path at an angle.

17. The turbine of claim 16, wherein the injection port is positioned about a suction side of the first guide blade at a throat thereof.

18. The turbine of claim 16, wherein the angle comprises about 135 degrees to about 150 degrees with respect to the flow path at a throat.

19. The turbine of claim 16, wherein the injection port comprises a slot in the first guide blade.

20. The turbine of claim 16, wherein the injection port comprises a plurality of apertures in the first guide blade.
